(19) United States
(12) Patent Application Publication
(10) Pub. No.: US 2006/0154109 A1
(43) Pub. Date: Jul. 13, 2006

(54) Tool holders for chip removing machining

(75) Inventor: Mats Ahlgren, Taby (SE)

Correspondence Address: DRINKER BIDDLE & REATH (DC), 1500 K STREET, N.W., SUITE 1100, WASHINGTON, DC, 20005-1209, US

(73) Assignee: SANDVIK Intellectual Property AB

(21) Appl. No.: 11/311,629

(22) Filed: Dec. 20, 2005

(30) Foreign Application Priority Data
Dec. 22, 2004 (SE) 0403174-6

(51) Int. Cl. B32B 9/00; B32B 19/00

(52) U.S. Cl. 428/698; 428/701; 428/702

(57) ABSTRACT

The present invention relates to a tool holder with a thin outermost coloring non-oxide layer whereby said color is created by thin film interference.

### BACKGROUND OF THE INVENTION

The present invention relates to tool holders for chip removing machining provided with an outermost thin film interference color layer.

By a tool holder, is in this application meant a holder for one or more cutting inserts for chip removing machining. Such holders are well known in the art and are shown, for example, in U.S. Pat. Nos. 5,685,672, 6,619,891 and 6,929,432, the specifications of which are herein incorporated by reference. Other types of tool holders to which the present invention is applicable will be apparent to the skilled artisan. The holder includes a base body on which at least one insert-receiving seat or other arrangement for receiving a cutting insert is disposed. For turning applications the tool holders are generally of an elongated shape and for milling applications rotational symmetric. The inserts are made of cemented carbide, cermet, ceramics, high-speed steel, tool steel or the superhard materials such as cubic boron nitride or diamond.

The holders are made from tool steel and manufactured by conventional chip removing machining methods to the desired shape and dimension. After that, the surface is treated in order to obtain a surface of black oxide. Finally, the surface is oiled to further protect it.

It would, of course, be very useful if tool holders could be given different colors as a guide to the end user to select the correct one for a certain machining operation but also for decorative reasons. Unfortunately, the number of colored compounds suitable for such purpose is limited. One method, which is often used, is anodization. Another possibility would be to use Physical Vapor Deposition (PVD).

### OBJECT AND SUMMARY OF THE INVENTION

It is an object of the present invention to provide a tool holder with different colors as a guide to the end user to select the correct one for a certain machining operation.

It is a further object of the present invention to provide a tool holder with a coloring layer with increased wear resistance.

It is a still further object of the present invention to provide a tool holder with a coloring layer that easily can be deposited.

It is yet another object of the present invention to provide a tool holder with a color that is consistent within a charge as well as between charges.

In accordance with the invention, there is provided a tool holder including in a thin outermost coloring non-oxide layer in which said color is created by thin film interference.

### DETAILED DESCRIPTION OF THE PREFERRED EMBODIMENTS OF THE INVENTION

According to the present invention a tool holder is colored on at least one surface by an outermost thin transparent non-oxide layer, preferably a carbide, nitride or carbonitride layer of a metal from the group comprising Groups IVB, VB or VIB of the periodic table, Al, Si and B or mixtures thereof, preferably Ti and/or Al. Its thickness is such that it is colored by thin film interference, i.e., a thickness of less than about 0.5 μm, preferably from about 0.05 to about 0.3 μm, most preferably from about 0.05 to less than about 0.2 μm. The body can be a tool steel.

The color layer may be the only layer but it may also be on top of a wear resistant functional coating. Preferably said color layer is in contact with a TiN-layer, with a thickness of from about 0.1 to about 5.0 μm.

In a preferred embodiment, said color layer is (Ti,Al)N, more specifically TiₓAl₁₋ₓN with x being greater than about 0.1 but less than about 0.9, preferably x being greater than about 0.4 but less than about 0.7, most preferably greater than about 0.4 but less than about 0.6.

Preferably, said layer is blue with a* being greater than about −20 but less than about 0, b* being greater than about −40 but less than about 0 and L* being greater than about 0 but less than about 95. In one preferred embodiment, a* is greater than about −20 but less than about −10. In another preferred embodiment, b* is greater than about −40 but less than about −20. The a*, b* and L* coordinates are well-known in the art as part of the CIELab system, a uniform device independent color space in which colors are located within a three-dimensional rectangular coordinate system. The three dimensions are lightness (L), redness/greenness (a) and yellowness/blueness (b).

The layers are deposited by PVD-technique, preferably by magnetron sputtering or cathodic arc evaporation. Said layers are easily deposited in a production scale equipment in situ with the same set-up as used for the functional wear resistant layers.

Said color layers can also be deposited with Plasma Assisted Chemical Vapor Deposition (PACVD).

The invention is additionally illustrated in connection with the following examples, which are to be considered as illustrative of the present invention. It should be understood, however, that the invention is not limited to the specific details of the examples.

### EXAMPLE 1

End mill tool holders were provided with a blue outer coating by a sputtering process. A foil 20×20 mm² large in the shape of a cylinder was coated at the same time. Both the tool holders and the foil were subject to the same 3-fold rotation. Ar, Kr and N₂ flow were regulated to 150, 85 and 70 sccm respectively. A negative substrate bias of 100 V was applied. First, a TiN layer of about 0.2 μm was deposited. On top of this TiN-layer a (Ti_{0.5}Al_{0.5})N layer was deposited using two Ti_{0.5}Al_{0.5}-targets as metal sources. By depositing the (Ti_{0.5}Al_{0.5})N layer for 23 minutes with a cathode power of 3.2 kW on each Ti_{0.5}Al_{0.5}-target a nice blue color was obtained. The L*, a* and b* values were measured on the foil using a Minolta Spectrophotometer CM-2500D with the following settings:

| | |
|---|---|
| Mask/Gloss | M/SCI |
| UV Setting | UV 100% |
| Illuminant1 | D65 |
| Observer | 10° |
| Display | DIFF & ABS. |

The following results were obtained: a*=−16, b*=−30 and L*=39.

### EXAMPLE 2

Example 1 was repeated but by depositing (Ti,Al)N for 23 minutes with a cathode power of 3.7 kW on each Ti_{0.5}Al_{0.5}-target. A blue color was obtained with the following results: a*=−18, b*=−23 and L*=46.

### EXAMPLE 3

Example 1 was repeated but by depositing (Ti,Al)N for 23 minutes with a cathode power of 5.7 kW on each Ti_{0.5}Al_{0.5}-target. A green color was obtained with the following results: a*=−14, b*=−7 and L*=56.

### EXAMPLE 4

Example 1 was repeated but Ar, Kr, and N₂ flows were changed to 250, 150 and 70 sccm respectively and depositing (Ti,Al)N for 23 minutes with a cathode power of 3.2 kW on each Ti_{0.5}Al_{0.5}-target. A deep blue color was obtained with the following results: a*=−3, b*=−39 and L*=29.

### EXAMPLE 5

Example 4 was repeated in its entirety after some time. Again a deep blue color was obtained with the following results: a*=−5, b*=−37 and L*=31.

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Tool holder including in a thin outermost coloring non-oxide layer in which said color is created by thin film interference.

2. A tool holder of claim 1 wherein said coloring layer has a thickness of less than about 0.5 μm.

3. A tool holder of claim 1 wherein said coloring layer is a carbide, nitride or carbonitride of a metal from the group consisting of metals from Groups IVB, VB or VIB of the periodic table, Al, Si and B or mixtures thereof.

4. A tool holder of claim 3 where in said metal is Ti and/or Al.

5. A tool holder of claim 4 wherein said layer is TiₓAl₁₋ₓN.

6. A tool holder of claim 5 wherein that x is greater than about 0.1 but less than about 0.9.

7. A tool holder of claim 1 wherein said layer is blue with a* greater than about −20 but less than about 0, b* greater than about −40 but less than about 0 and L* greater than about 0 but less than about 95.

8. A tool holder of claim 5 wherein said layer is deposited on top of a TiN-layer.

9. A tool holder of claim 6 wherein x is greater than about 0.4 but less than about 0.7.

10. A tool holder of claim 9 wherein x is greater than about 0.4 but less than about 0.6.

11. A tool holder of claim 8 wherein the TiN layer is from about 0.1 to about 5 μm thick.
